(19) United States
(12) Patent Application Publication
(10) Pub. No.: US 2003/0076287 A1
(43) Pub. Date: Apr. 24, 2003

(54) Large surface display apparatus

(75) Inventors: Reiner Bayrle, Langenau (DE); Otto Bader, Warthausen (DE); Wolfgang Borst, Weissenhorn (DE)

Correspondence Address: DORITY & MANNING, P.A., POST OFFICE BOX 1449, GREENVILLE, SC, 29602-1449, US

(73) Assignee: AEG Gesellschaft fur moderne Informationssysteme mbH

(21) Appl. No.: 10/158,410

(22) Filed: May 28, 2002

(30) Foreign Application Priority Data
May 25, 2001 (DE) 20108797.9

(51) Int. Cl. G09G 3/36

(52) U.S. Cl. 345/87; 345/90

(57) ABSTRACT

A large surface display apparatus is provided with at least one display field, a control set, a first connection line, and a second connection line. The display field has LCD-modules to display changing information. In one aspect, the first connection line is a light wave conductor and the second connection line is a metallic conductor.

The invention concerns a large surface display apparatus in accord with the generic concept of claim 1, which large surface display is appropriate for the exhibition of continually changing data on, for instance, the front of a building.

DE 296 07 786 U1 makes known a large surface LCD-display apparatus, with which changing information is shown on a multiplicity of LCD-displays modules which form a common display field. By the use of LCD-display modules the achievement is gained, that the display field, when not activated by control, is light transmitting, that is, transparent. For the control of the individual display modules, corresponding signal lines or control lines must be conducted to each of the said modules. This unavoidably leads to the situation, that in the edge areas of the LCD-module optically dark areas or borders must be provided, behind which the signal lines are run. In the case of large surface displays and the use of metallic signal lines, an undesirable antennae action arises in the connecting wiring, that is, such display apparatuses disturb electronic equipment in the surrounding environment, which makes necessary a complex shielding of the said connecting wiring.

Thus it is the purpose of the present invention to so design large area display apparatuses, that, at an acceptable cost, the disturbing radiation from the display apparatus is reduced to a minimum.

The achievement of this purpose is carried out by the features of claim 1.

By means of the use of light wave conductors between the main control and the subordinate control, which lead to the individual display modules, that is, by means of a “conductor-mix”, there is gained, first, that extremely long copper supply lines from the main control to the subordinate controls are avoided and thus the antenna action is reduced. Second, at the same time and by means of the retention of the metal conductors from the subordinate control to the individual display modules—that is, the module-drivers—then, recourse is taken to already known, conventionally developed technology. Moreover, by means of the invented combination of light wave conductors and conventional metallic conductors, the number of the connecting elements, that is the transfer elements from optical signals into conventional electrical signals is reduced to a bearable level.

Fundamentally, the use of light wave conductors in such display apparatuses can show problems, since tight radial bends could occur because of the limitations of available space for the running of lines. Radial bends smaller than 5 cm are to be avoided where light wave conductors are concerned, since undesired back reflections and damage can occur. Using the conductor mix consisting of light wave conductors and conventional metal conductors, light wave conductors can be installed in nearly straight lines. Then, wherever a sharply kinked curve is necessary, transducers for the conversion of the optical signal into an electrical signal and vice versa can be provided.

In this way, retaining a critical bending radius where needed in the case of light wave conductors becomes possible without problems.

Additionally, by means of the use of light wave conductors between the main control and the subordinate controls, doing without complex data protection procedures and its attendant control becomes possible. As a result, the data transmission rate is essentially increased, that is the same useful data quantity can be transmitted with a reduced baud rate. This reduced amount of management in the data transmission is a result of the higher degree of security of the data transmission by light wave conductors as compared to that of transmission by conventional copper lines.

Transducers for the changing of optical signals into electrical signals and back again are very expensive. By means of the invented conductor mix, the number of the transducer elements is reduced to an economically sustainable level.

In accord with an advantageous embodiment of the invention, in accord with claim 2, the regulation of the individual subordinate controls by the main control is in series. By this means the number of the necessary light wave conductors is lessened, which is of advantage because of the constricted available space.

In another advantageous embodiment of the invention in accord with claim 3, the control of the individual display modules by the respective subordinate control is also carried out in series. In this way, the number of the necessary supply lines is reduced.

In a further advantageous embodiment of the invention in accord with claim 4, some of the subordinate control entities are designed as color controls, which control color modules. The color modules are individual display modules or parts thereof An example embodiment thereof has been made known by the German Utility Patent DE 200 20165.4 U1. Insofar as is applicable, cognizance is taken in full of the DE 200 20165.4 U1.

In a further advantageous embodiment of the invention in accord with claim 5, the display module is placed in a matrix pattern with lines and columns. In this way, different large display apparatuses can be combined in a simple manner.

In yet another advantageous embodiment of the invention in accord with claim 6, module drivers for the individual display module are placed on the sides at the rim, and respectively two display modules face one another, so that their module driver then lies on the two oppositely situated outside longitudinal sides. By this arrangement, the optically active surface is increased. Details in this respect have been made known by the German patent application DE 100 23 378.3. Insofar as applicable, cognizance is taken in full of DE 100 23 378.3.

Further details of the invention can be found in the following description of a preferred embodiment with the aid of the drawings. There is shown in:

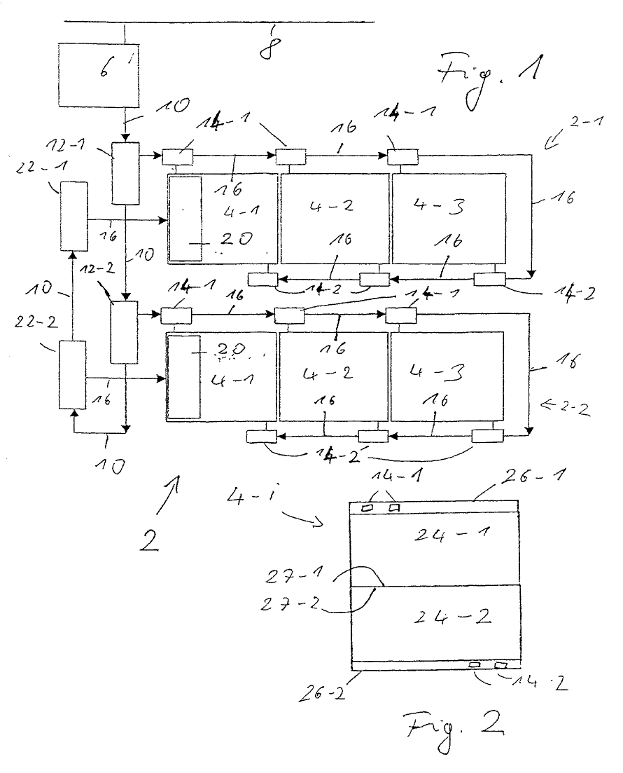

FIG. 1, a schematic presentation of an exemplary embodiment of the invention.

FIG. 2, a schematic presentation of an LCD-module in accord with the embodiment of FIG. 1.

FIG. 1 shows schematically a display apparatus in a matrix arrangement with a display field 2, which is formed by means of a first modular group depicted as a first display line 2-1 and a second module group shown as a second display line 2-2. Each of the two module groups, in combination called 2-i, encompasses three rectangular or square LCD display modules 4-1, 4-2 and 4-3. The control of the display arrangement is carried out by means of a main control 6 to which, for example, the information to be displayed is input by an Ethernet LAN 8. In the main control 6 the signals are correspondingly processed and converted to optical signals. The optical signals are then introduced through a first connection in the form of a light wave conductor 10, proceeding then in series next to a first subordinate control 12-1 for the first line 2-1 and subsequently through a second subordinate control 12-2 to be introduced into the second line 2-2.

The subordinate controls 12-i incorporate a coupling device, i.e., a transducer (not further described), by means of which the said incoming optical signals are converted into electrical signals. Each of the LCD-display modules 4-i is equipped, respectively, with first and a second module driver 14-1, 14-2. The connection between the first subordinate control 12-1 and the first and second module drive device 14-i of the first display line 2-1 is done by means of second connection means in the form of conventional copper lines 16. The running of the said lines, is such that in this case, starting from the first subordinate control 12-1, in series, the first module drivers 14-1 of the three LCD-display modules 4-1, 4-2 and 4-3 are controlled. Subsequently the control extends to the second module drivers 14-2 of the three LCD display modules 4-3, 4-2 and 4-1.

A portion of the LCD-display module 4-1 in the first and in the second module group 2-1 and 2-2 are designed to be color modules 20. The construction of an LCD-display as a color module is possible to accomplish in various ways, for example, in the form of a TFT-Display (Thin Film Transistor), by color filters in front of the respective pixel elements, or even in the form of a colored backlighting, as this is provided in the present embodiment example of the invention. For a concrete formulation of the color module 20, reference is made to the German Utility Patent DE 200 20 265.4. The control of the color module 20 is done, in any case, by means of metal conductors 16 from a first color control 22-1 for the first line 2-1 and from a second color control 22-2 for the second display line 2-2. The conduction of the signals to the color controls 22-i is executed in series by means of light wave conductor 10, said signals emanating from second subordinate control 12-2 to the second color control 22-2 and on to the first color control 22-1.

FIG. 2 shows, schematically, on of the LCD display modules 4-i. Each of the LCD-display modules 4-i is constructed from a first display half 24-1 and a second display half 24-2. The two display halves are rectangular in shape and accordingly the long sides are respectively designated 26-1, 26-2 and 27-1 and 27-2 for the first and second halves respectively. On an edge strip of the first long side 26-1 of the first display half 24-1 is to be found the first module driver 14-1 of the respective LCD display module 4-i. On an edge strip of the first long side 26-2 of the second display half 24-2 is placed the second module driver 14-2 of the respective LCD-display modules. The two LCD display halves 24-1 and 24-2 are the same size and are contiguously in contact with one another along their long sides 27-1 and 27-2.

Large surface, in the concept of “large surface display” indicates from several to a few hundred square meters. The number of the module groups, i.e., display lines and/or the number of the LCD-display modules per module group increases with the extent of the size of the display apparatus.

### REFERENCE NUMBERS AND ITEMS

2 Display field

2-i Module group, display line

4-i Display module

6 Principal control

8 Ethernet LAN

10 First connection conductor, i.e. light wave conductor

12-i Subordinate control

14-i Module drivers

16 Second connection conductor, i.e. metallic conductor

20 Color module

22-i Color control

24-i Display halves

26-i First long side of rectangle 24-i

27-i second long side of rectangle 24-i

Claimed is:

1. A large surface display apparatus with at least one display field (2), which said display field is comprised of a plurality of appropriate display modules, in particular LCD-display modules (4-i) which are placed in close juxtaposition with one another and extend themselves in area for an exhibition of changeable information, and a control set (6, 12-i, 14-i, 22-i) with at least one main control (6), a plurality of subordinate controls (12-i, 22-i), which are respectively responsive to the one main control (6), also a plurality of module drivers (14-i), each of which governs one of the said plurality of the display modules (4-i), a first connection line (10) between the main control (6) and the subordinate controllers (12-i, 22-i), a second connection line (16) between the subordinate control units (12-i, 22-i) and between said module drivers (14-i), wherein the display module (4-i) is joined to a plurality of module groups (2-i), to each of which one of the subordinate controls (12-i) is assigned as a group control apparatus (12-i), whereby the main control (6) is connected with the individual subordinate controls (12-i, 22-i) by means of the first connection line and whereby the group control apparatus (12-i) of the respective module group (2-i), is connected to individual module drivers (14-i) of the respective module group (2-i) by means of the second conductor line (16).
therein characterized, in that the first connection line is a light wave conductor (10) and the second connection line is a metallic conductor (16).

2. A large surface display apparatus in accord with claim 1, therein characterized, in that the main control (6) is connected in series with the individual subordinate controls (12-i, 22-i) by means of a light wave conductor (10).

3. A large surface display apparatus in accord with claim 1 or 2, therein characterized, in that the group control (12-i) of the respective module group (2-i) is connected in series through the metal conductor (16) with the individual module drivers (14-i) of the respective module group (2-i).

4. A large surface display apparatus in accord with one of the foregoing claims, therein characterized, in that at least one of the LCD-display modules (4-i) incorporates a color module (20), in order to produce a colored display, and in that at least one of the subordinate controls (12-i, 22-i) is designed as a color control (22-i) and is connected through the metal conductors (16) with the color module (20).

5. A large surface display apparatus in accord with one of the foregoing claims, therein characterized, in that the individual LCD display module (4-i) is rectangular or square, and is set in a matrix with lines (2-i) columns.

6. A large surface display apparatus in accord with claim 5, therein characterized, in that the modul-drivers (14-i) are always placed along opposite lying long sides (26-i) of the LCD display module (4-i).
